(19) United States
(12) Patent Application Publication
(10) Pub. No.: US 2007/0261977 A1
(43) Pub. Date: Nov. 15, 2007

(54) Waterproof gear container

(75) Inventor: Tatsuya Sakai, Irvine, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Shimano American Corporation, Irvine, CA (US)

(21) Appl. No.: 11/409,334

(22) Filed: Apr. 22, 2006

(51) Int. Cl. B65D 85/00; A01K 97/00; A01K 97/04

(52) U.S. Cl. 206/315.11; 43/54.1; 224/920

(57) ABSTRACT

A waterproof container including an outer shell having a lid and a bottom portion connected by a zipper, an inner liner secured to and positioned within the outer shell, and a gap defined between the outer shell and the inner liner. The bottom portion has a drainage hole defined therein that communicates the gap with the exterior of the container. Water that enters through the zipper falls through the gap and exits through the drainage hole.

### FIELD OF THE INVENTION

The present invention relates generally to gear containers and, more particularly, to a waterproof gear container.

### BACKGROUND OF THE INVENTION

People often engage in activities near or around water. For example, sunbathing, surfing, boating and fishing are all done near, in or on the water. Often while performing these activities persons try to prevent their personal belongings, such as watches, wallets, food, fishing tackle and the like from getting wet. Bags have been devised for keeping articles dry, however, most bags sold as “waterproof” in the outdoor gear market use waterproof zippers and have a heat-welded assembly between the zipper and outer shell of the bag. This prevents the water from seeping through the stitch holes, which typically happens if the zipper is sewed to the outer shell of the bag. However, waterproof zippers and heat-welding are expensive.

Accordingly, a need exists for an inexpensive container that helps prevent personal items from getting wet while engaging in activities on or near the water.

### SUMMARY OF THE PREFERRED EMBODIMENTS

In accordance with a first aspect of the present invention, there is provided a container including an outer shell having a lid and a bottom portion connected by a zipper, an inner liner secured to and positioned within the outer shell, and a gap defined between the outer shell and the inner liner. The bottom portion has a drainage hole defined therein that communicates the gap with the exterior of the container. Water that enters through the zipper falls through the gap and exits through the drainage hole. In a preferred embodiment, the top edge of the inner liner is secured to the top edge of the bottom portion and the inner liner comprises a bottom and four upwardly extending sidewalls that extend outwardly at the top thereof.

In accordance with another embodiment of the present invention, there is provided a method of storing live bait. The method includes the steps of providing a container having an outer shell that comprises a bottom portion and a lid and providing an air pump having a hose. The outer shell defines a main compartment therein and has an opening defined therein. The method also includes the steps of inserting an end of the hose through the opening in the outer shell, positioning the end of the hose in the main compartment, at least partially filling the main compartment with water, placing live bait in the water, and turning on the air pump, thereby pumping air into the water. In a preferred embodiment, the container includes an inner liner defining an inner compartment that is secured to and positioned within the outer shell. A gap is defined between the outer shell and the inner liner and the end of the hose is positioned within the inner compartment.

### BRIEF DESCRIPTION OF THE DRAWINGS

The invention may be more readily understood by referring to the accompanying drawings in which:

FIG. 1 is a perspective view of a waterproof gear container in accordance with a preferred embodiment of the present invention;

FIG. 2 is a front cross-sectional elevational view of the waterproof gear container of FIG. 1 taken along line 2-2 of FIG. 1;

FIG. 3 is a front cross-sectional elevational view of another embodiment of a waterproof gear container;

FIG. 4 is a side cross-sectional elevational view of the waterproof gear container of FIG. 1; and

FIG. 5 is a read elevational view of the waterproof gear container of FIG. 1 showing the air pump and hose.

Like numerals refer to like parts throughout the several views of the drawings.

### DETAILED DESCRIPTION OF THE PREFERRED EMBODIMENTS

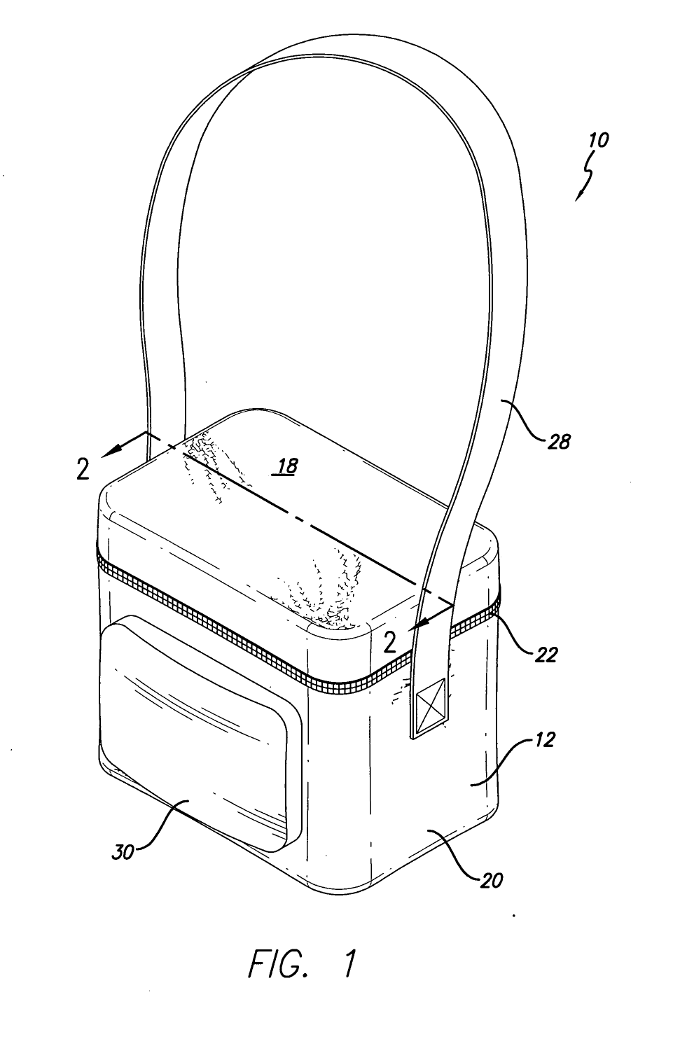

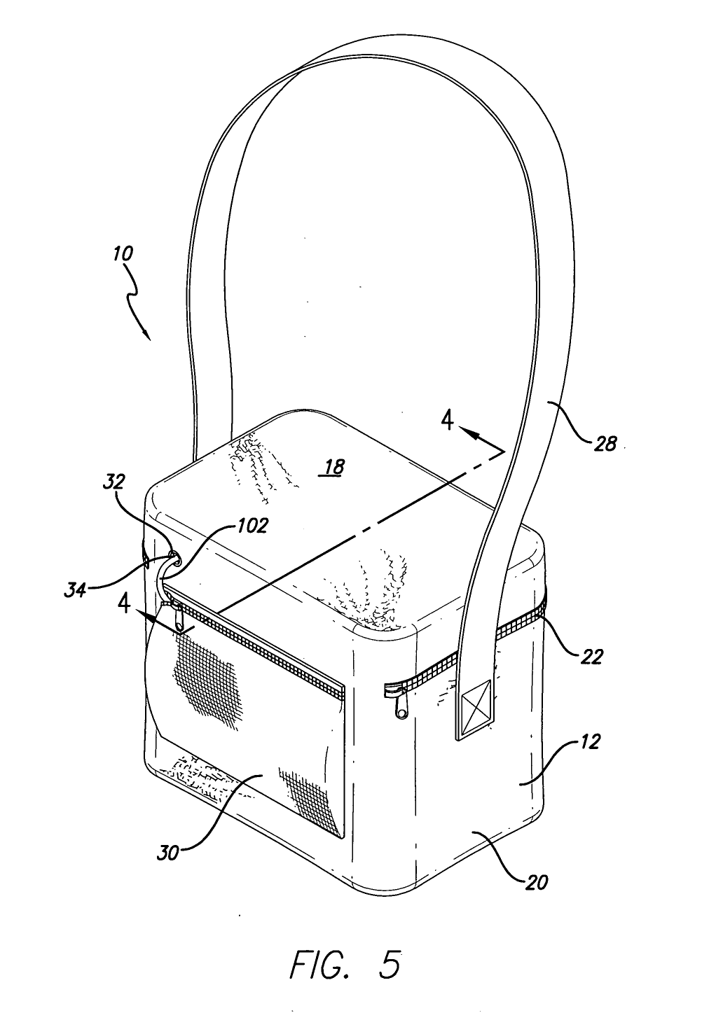

Referring to FIGS. 1-5, a waterproof gear container (often referred to herein as a “container”) 10 for protecting personal items and the like in wet environments is shown. The container 10 generally includes an outer shell 12 and an inner liner 14 with a gap 16 defined therebetween.

It will be appreciated that terms such as “top,” “bottom,” “below,” and “side” used herein are used merely for ease of description and refer to the orientation of the components as shown in the figures. It should be understood that any orientation of the various embodiments of the container 10 and the components thereof described herein is within the scope of the present invention.

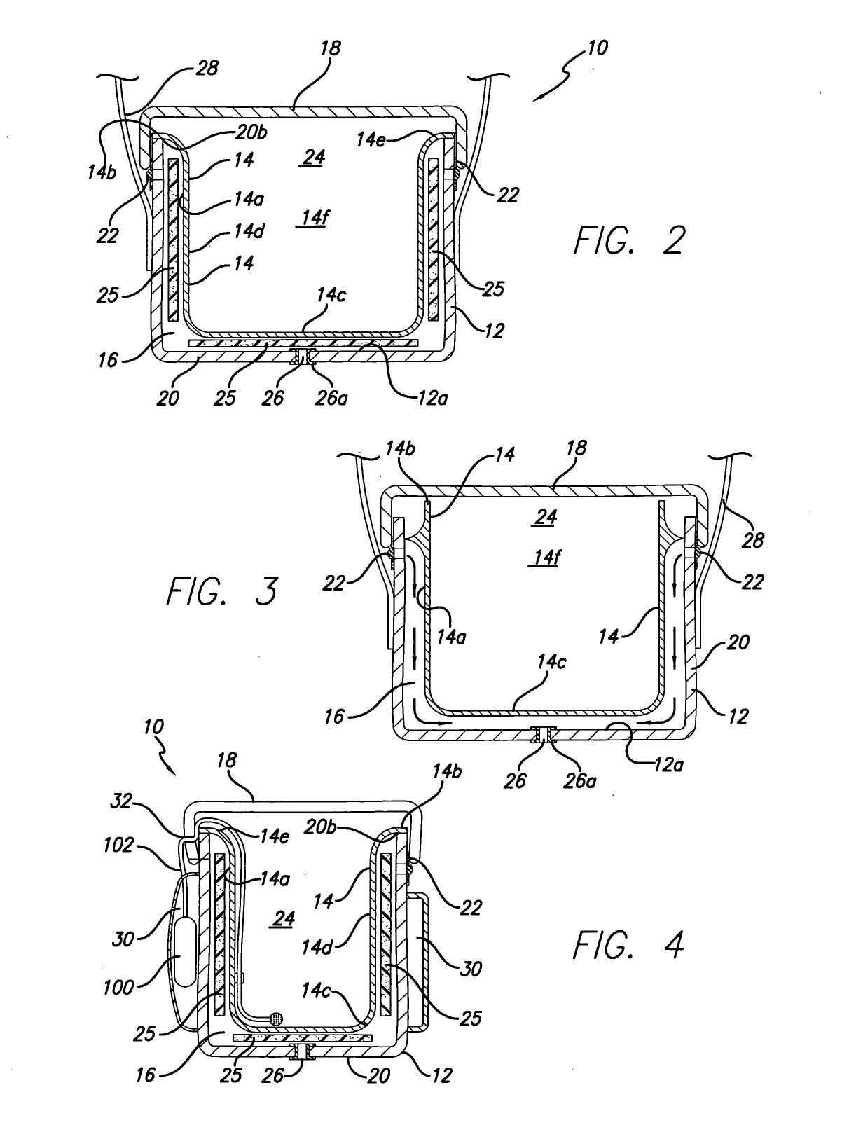

As shown in FIG. 2, the outer shell 12 includes a lid 18 and a bottom portion 20 secured together by a zipper 22. In a preferred embodiment, the zipper 22 is sewn or stitched on. As discussed above, this is cheaper than providing a waterproof zipper. However, in another embodiment, a waterproof zipper can be used. The zipper 22 preferably extends around at least three sides of the outer shell 12, but not all the way around. This allows the container 10 to be opened by pivotably raising the lid 18. In another embodiment, the zipper 22 can extend around the entire outer shell 12 and can be removable. The use of zippers is well known in the art.

Outer shell 12 defines a main compartment 24 therein. Inner liner 14 is positioned within main compartment 24 and secured to outer shell 12 such that gap 16 is defined between an inner surface 12a of outer shell 12 and an outer surface 14a of inner liner 14, as is best shown in FIGS. 2 and 3.

As shown in FIG. 2, the inner liner 14 is preferably formed as a container with an open top. The inner liner includes a bottom 14c and four upwardly extending sidewalls 14d that end at a top edge 14b. To form the gap 16 between the inner liner 14 and outer shell 12, in a preferred embodiment, the sidewalls 14d of the inner liner 14 include an upper portion 14e that extends outwardly. For example, as shown in FIG. 2, the upper portion of the sidewalls 14d curve outwardly. In another embodiment the upper portion of the sidewalls can extend outwardly at an angle (either obtuse, right or acute). It will be understood that the outer shell 12 and inner layer 14 and the components thereof can be made of a rigid, soft or soft-sided material.

The inner liner 14 is comprised of a waterproof material and can be comprised of a single piece of material or several pieces that are heat-welded at the corners. For example, the inner liner 14 can be made of a heavy tarpaulin material, such as polyvinyl chloride (PVC) or the like. Preferably, the inner liner 14 is sewn to the bottom portion 20 of the outer shell 12 at, near or along their top edges 14b and 20b. However, as shown in FIG. 3, the inner liner 14 can also be sewn to the inner surface 12a of outer shell 12 along at least one and preferably a number of connection points. In this embodiment, these connection points are located just below the zipper 22, and, the zipper 22 is sewn onto the outer shell 12 (and between the lid 18 and bottom portion 20) at a position below the top edge 14b of the inner liner. In another embodiment, the inner liner 14 can be secured to the outer shell 12 by glue, adhesive, heat sealing, screws, bolts, rivets or other known connection method.

Outer shell 12 is preferably also comprised of a waterproof material, such as PVC. In a preferred embodiment, both the lid 18 and bottom portion 20 are soft-sided. The lid 18 is preferably heat welded at the corners to keep the lid 18 waterproof. In a preferred embodiment (as shown in FIGS. 2 and 4), the bottom portion 20 includes a buoyant material 25, such as Styrofoam or EPE soft foam, to allow the container 10 to float. For example, the buoyant material 25 can be located in gap 16 and between the outer shell 12 and inner liner 14. However, this is not a limitation on the present invention. For example, buoyant material 25 could be placed in the lid 18 or in the sidewalls 14d.

When located in gap 16, preferably, the cross-section of the buoyant material 25 is smaller than gap 16, as shown in FIG. 2. This allows any water that enters gap 16 to get around the buoyant material 25 to exit through drainage hole 26. In another embodiment, the buoyant material 25 can be located between the inner and outer surfaces of the bottom portion 20.

As shown in FIG. 2, in a preferred embodiment, the bottom portion 20 includes a drainage hole 26 defined in the bottom thereof. Hole 26 can include a grommet 26a for lining the hole 26 and preventing water from getting in between the inner and outer surfaces of the bottom 20. In another embodiment, the inner and outer layers of the bottom 20 can be heat welded or sealed together to form the drainage hole 26.

In use, with the zipper 22 unzipped, the lid 18 is opened and articles are placed in the inner compartment defined by the inner container 14. The lid 18 is then closed, and the zipper 22 is zipped, thereby securing the lid 18 to the bottom portion 20. In a situation where the container 10 encounters water, the water enters the container 10 through the stitch holes of zipper 22. Due to gravity, the water falls through gap 16 (the water direction is shown in FIGS. 2 and 3 by the arrows) and then drains through the drainage hole 26. With this configuration, when water enters through the zipper it cannot get into the inner compartment.

In a preferred embodiment, the container 10 includes a strap 28 secured thereto. However, this is not a limitation on the present invention. The strap 28 is preferably sewn to the outside of the outer shell 12, but can be secured by other methods, such as glue, adhesive, screws, bolts, rivets or other known connection methods. The container 10 can also include other components, such as side or top pockets 30, non-skid, non-slip material on the bottom for extra grip on wet surfaces, handles and the like.

As shown in FIG. 4, in a preferred embodiment of the invention, the container can be used as a live-well for bait, such as shrimp or minnows. In this embodiment, the container 10 is used in conjunction with an air pump 100 and hose 102, and includes an opening 32 therein for inserting the hose 102. The opening 32 is defined in the lid 18. The opening can include a securing member 34 for holding the hose 102 in place when in use. For example, as shown in FIG. 4, the securing member 34 can include two intersecting slits that accept and retain the hose 34. Also, another securing member can be located within inner compartment 14f for retaining the hose 102 in place. For example, this securing member can include hook and loop material.

In use, the end of the hose 102 is inserted through opening 32 and is pulled over the top edges 14b and 20b of the inner liner 14 and bottom portion 20 and is positioned inside the inner compartment 14f (which is also part of the main compartment) defined by the bottom 14c and sidewalls 14d of the inner liner 14. Water and live bait can then be placed in the inner compartment 14f. The air pump 100 pumps air through the hose 102 and into the water, thereby keeping the bait alive.

In a preferred embodiment, the air pump 100 is stored a pocket 30 located on the back of the outer shell 12. However, this is not a limitation on the present invention.

In another embodiment, the container can include insulation therein (e.g., the inner liner is an insulated PVC material) and can be used as a cooler for drinks or food.

Container 10 can have a round, oval, square, rectangular or other shaped cross-section when viewed from the top or the side.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A container comprising:
a. an outer shell having a bottom portion, the outer shell including a zipper, and the bottom portion having a drainage hole defined therein,
b. an inner liner positioned within the outer shell, and
c. a gap defined between the outer shell and the inner liner, wherein the drainage hole communicates the gap with the exterior of the outer shell.

2. The container of claim 1 wherein the drainage hole is defined in the bottom of the outer shell.

3. The container of claim 1 wherein the outer shell includes a lid, and wherein the zipper is secured between the lid and bottom portion by sewing.

4. The container of claim 1 wherein the inner liner has a top edge, and wherein the top edge is positioned above the zipper.

5. The container of claim 4 wherein the bottom portion has a top edge, and wherein the top edge of the inner liner is secured to the top edge of the bottom portion.

6. The container of claim 5 wherein the inner liner comprises a bottom and four upwardly extending sidewalls, and wherein the sidewalls extend outwardly at the top thereof.

7. The container of claim 6 wherein the sidewalls curve outwardly at the top thereof.

8. The container of claim 1 wherein the gap is defined between an outer surface of the inner liner and an inner surface of the outer shell.

9. The container of claim 1 wherein the outer shell and inner liner are made of waterproof material.

10. The container of claim 1 further comprising a shoulder strap attached to the outer shell.

11. The container of claim 1 wherein the bottom portion comprises a buoyant material.

12. The container of claim 1 in combination with an air pump having a hose, wherein the lid has an opening for receiving the hose defined therein.

13. The container of claim 1 wherein liquid passing through the zipper can pass into the gap and through the drainage hole.

14. A method of storing live bait, the method comprising the steps of:
providing a container having an outer shell that comprises a bottom portion and a lid, wherein the outer shell defines a main compartment therein and has an opening defined therein,
providing an air pump having a hose,
inserting an end of the hose through the opening in the outer shell,
positioning the end of the hose in the main compartment,
at least partially filling the main compartment with water,
placing live bait in the water, and
turning on the air pump, thereby pumping air into the water.

15. The method of claim 14 wherein the container further comprises an inner liner defining an inner compartment, wherein the inner liner is secured to and positioned within the outer shell, wherein a gap is defined between the outer shell and the inner liner, and wherein the end of the hose is positioned within the inner compartment.

16. The method of claim 15 wherein the opening in the outer shell is defined in the lid.

17. The method of claim 16 wherein the opening includes a securing member.

18. The method of claim 15 wherein the bottom portion includes a drainage hole defined therein.

19. The method of claim 15 wherein the bottom portion and inner liner each include a top edge, and wherein the bottom portion and inner liner are secured to one another along their top edges.

20. The method of claim 14 wherein the outer shell includes a pocket, and wherein the air pump is located in the pocket.
